(19) United States
(12) Patent Application Publication
(10) Pub. No.: US 2010/0063624 A1
(43) Pub. Date: Mar. 11, 2010

(54) Monitoring Method And System

(76) Inventor: Kieran Richard Hyland, County Cork (IE)

Correspondence Address: Valauskas & Pine LLC, 150 South Wacker Drive, Suite 620, Chicago, IL, 60606, US

(21) Appl. No.: 12/309,777

(22) PCT Filed: Aug. 2, 2007
(86) PCT No.: PCT/EP2007/058044

§ 371 Date: Oct. 15, 2009

(30) Foreign Application Priority Data
Aug. 2, 2006 (IE) S2006/0577

(51) Int. Cl. G06F 17/00; G06F 17/10; H04N 5/225

(52) U.S. Cl. 700/237; 701/300; 348/207.99; 348/E05.024

(57) ABSTRACT

This invention relates to a monitoring method and system for monitoring the dispensing of medicaments in a hospital from a portable medicament dispensing station. The medicament dispensing station 3 has a first identification means 9 and a second identification means 13 for capturing identifiers relating to an individual wishing to dispense a medicament. A releasable locking mechanism 23 is provided that will allow dispensing of medicaments on appropriate identifiers being captured and authenticated. The identifier data is transmitted to a monitoring unit 5 over a communications network 8 and is stored in a remote monitoring unit memory 7 for future reference. By implementing such a system and method, tampering with the data input to the system is obviated and traceability and accountability are facilitated.

### INTRODUCTION

This invention relates to a monitoring method and system and in particular to a method and system for monitoring the dispensing of medicaments in a hospital.

In this specification the term medicament has been used throughout and is intended to include blood products as well as medicinal drugs administered by medical personnel. The term hospital is intended to encompass not only hospitals in the traditional sense but also clinics, nursing homes and other environments where blood products and/or medicinal drugs are commonly administered.

One of the major causes of accidental deaths in hospitals today can be attributed to administration of incorrect medicaments to the patients by medical staff. It has been estimated that in the region of nine thousand people died in the United States in 2006 due to misadministration of medicaments to them by medical staff. Apart from the human cost, the cost of malpractice suits can also be crippling on the hospitals. It is therefore in the best interests of the hospitals to introduce tighter controls and provide comprehensive records so that they may establish accountability in the case of such a tragedy and attempt to reduce the number of accidents occurring.

Heretofore, hospitals have tackled the problem by providing paper-based or electronic records completed by the medical staff themselves in the hospitals, detailing their actions over the course of their shift. These records were stored for subsequent analysis if needed. However, with the known systems, it was quite simple to input erroneous data into the system and furthermore, such systems were highly susceptible to fraud and records could be altered or input incorrectly deliberately without significant difficulty. Accordingly, these systems have proved inadequate when attempting to establish accountability. Furthermore, these systems typically store a record of the actions of employees which may be used for auditing and accountability at some time in the future but they in no way assist in the prevention of errors by the employees before they happen.

It is an object therefore of the present invention to provide a method and system for monitoring the dispensing of medicaments in a hospital that overcome at least some of these difficulties that is both simple to implement and relatively simple to operate.

### STATEMENTS OF INVENTION

According to the invention there is provided a method of monitoring the dispensing of medicaments in a hospital, in a system comprising a portable medicament dispensing station, a remote monitoring unit having memory and a communication network connecting the medicament dispensing station and the monitoring unit, each time an individual attempts to dispense medicaments from the medicament dispensing station the method comprising the steps of: the medicament dispensing station capturing a first identifier relating to the individual attempting to dispense medicaments from the medicament dispensing station; the medicament dispensing station capturing a second identifier relating to the individual attempting to dispense medicaments from the medicament dispensing station; the medicament dispensing station capturing the time at which the individual attempts to dispense medicaments from the medicament dispensing station; transmitting the captured first identifier, second identifier and time from the medicament dispensing station to the remote monitoring unit over the communications network; the remote monitoring unit storing the captured first identifier, second identifier and time in remote monitoring unit memory for future reference.

By having such a method, it will be possible to positively identify the individuals responsible for administering the medicaments with 100% certainty and the hospitals can trace the individuals responsible and take appropriate action in the event of an accidental misadministration of a medicament. Furthermore, as two separate and distinct types of identification are captured and the data is stored in a remote monitoring server, the opportunity for fraud is practically nil. Preferably, information relating to the patient and the medicament being administered may also be captured. If the nurse or other individual responsible for dispensing the medicaments enters the information onto the system that they have provided a certain patient with their required prescribed medicaments, a record of that entry will be taken, as well as a record of the individual that inserted the record onto the system. Subsequent changing of the records by the nurse will not be possible and if a query should arise about the manner in which medicaments were dispensed to that particular patient, a history may be obtained for the particular patient, along with a log of the nurse that provided them with their medicaments and similarly, a record of the medicaments dispensed by a particular nurse may also be obtained if necessary. This auditing system allows for a very comprehensive reporting method to be implemented and reports may be generated in a relatively short space of time.

In one embodiment of the invention there is provided a method in which the step of capturing a first identifier comprises capturing an identification code from the individual.

In another embodiment of the invention there is provided a method in which the step of capturing a second identifier comprises capturing a photographic image of the individual. Alternatively, the step of capturing a second identifier comprises capturing a video clip of the individual. As a further alternative still, the step of capturing a second identifier comprises capturing biometric data of the individual.

In another embodiment of the invention there is provided a method in which the method further comprises capturing position data relating to the individual in the hospital when they attempt to dispense medicaments, transmitting the position data to the monitoring unit and storing the position data in memory.

In a further embodiment of the invention there is provided a method in which the medicament dispensing station further comprises a releasable locking mechanism and in which the method further comprises the step of the releasable locking mechanism only being released on the medicament dispensing station capturing both the first and second identifiers.

In one embodiment, the method comprises the step of authenticating the individual from at least one of the first and second identifiers and releasing the releasable locking mechanism on the individual being authenticated. In another embodiment, the step of authenticating the individual comprises the monitoring unit comparing at least one of the first and second identifiers with data relating to the individual in memory and sending an authentication response to the medicament dispensing station permitting or refusing release of the locking mechanism depending on the comparison of the identifier and the data in memory.

In a further embodiment of the invention there is provided a method in which the system further comprises a separate remote database having personnel records of individuals in the hospital and the method of monitoring the dispensing of medicaments further comprises the step of matching one of the captured first identifier and second identifier in the remote monitoring unit memory to one of the personnel records in the database.

In one embodiment of the invention there is provided a medicament dispensing monitoring system comprising at least one portable medicament dispensing station and a remote monitoring unit, in communication with each other by way of a communication network, the monitoring unit having memory for storage of monitoring data thereon, the medicament dispensing station having a first identification means to receive a first identifier relating to an individual dispensing medicaments from the medicament dispensing station and a second identification means to receive a second identifier relating to the individual dispensing medicaments from the medicament dispensing station and a clock, the medicament dispensing station further comprising means to transmit the first and second identifiers along with time data to the remote monitoring computer over the communication network and the monitoring computer having means to store the first and second identifiers and the time data in memory as monitoring data.

In another embodiment of the invention there is provided a system in which the first identification means further comprises means to receive an identification code from the individual. In a further embodiment of the invention there is provided a medicament dispensing monitoring system in which the second identification means further comprises means to capture a photographic image of the individual. Alternatively, the second identification means further comprises means to capture a video clip of the individual. As a further still alternative, the second identification means comprises means to capture biometric data of the individual.

In a further embodiment of the invention there is provided a system in which the system further comprises means to capture position data relating to the individual.

In one embodiment of the invention there is provided a system in which the medicament dispensing station is further provided with a releasable locking mechanism, the releasable locking mechanism being released on the medicament dispensing station capturing both the first and second identifiers.

In another embodiment of the invention there is provided a system in which the system comprises means to authenticate at least one of the first and second identifiers and means to release the locking mechanism on authentication of at least one of the identifiers. In a further embodiment of the invention, the system comprises a separate remote database having personnel records of individuals in the hospital and means to match one of the captured first identifier and second identifier in the remote monitoring unit memory with one of the personnel records in the database.

In one embodiment of the invention, the medicament dispensing unit has a releasable locking mechanism for preventing the dispensing of medicaments, the locking mechanism being releasable on input of predetermined information into a data entry unit on the medicament dispensing station. In one embodiment, the predetermined information comprises one or more of a patient identifier, a prescription identifier and an individual identifier. By having the patient identifier, the prescription identifier which may include the dosage requirement and/or the medicament name, and an individual identifier, it is possible to determine what medicament is about to be dispensed, to which patient and by whom. A record of this may be taken and furthermore before the medicament is actually dispensed to the individual to give to the patient, a check may be made to ensure the correct medicament is actually being dispensed in the correct dosage. This will alert the individual dispensing the medicament that they may be potentially making an error and, if necessary, the releasable locking mechanism may not be allowed to release unless an overriding authorisation is given by an authorised individual such as a ward sister or physician. In a further embodiment of the invention, the predetermined information is compared against access information stored in memory.

In one embodiment of the invention there is provided a method of monitoring work practices of an individual in a workplace, in a system comprising a data entry module, a remote monitoring unit having memory and a communication network connecting the data entry module and the monitoring unit, the individual having an identification tag thereon and the system having means to determine the position of the individual wearing the identification tag in the workplace over time, the method comprising the steps of: tracking the position over time of the individual in the workplace; sending the position data of the individual to the monitoring unit for storage in monitoring unit memory; the individual entering task data in the data entry module indicating that a task has been completed along with data identifying the individual; sending the task data to the remote monitoring unit for storage in monitoring unit memory; collating the position data and the task data for subsequent inspection. The identification data could be one or more forms of identification including a personal identification code, a video clip, a photographic image, biometric data including fingerprint, retina and/or iris scan data.

In another embodiment of the invention there is provided a method in which the communication network is a low powered ZigBee network comprising a plurality of fixed nodes and the identification tag worn by the individual comprises a wireless mobile node of the ZigBee network, and in which the method step of tracking the position over time of the individual in the workplace further comprises tracking the position over time of the wireless mobile node in the ZigBee network.

In a further embodiment of the invention there is provided a method in which there is provided a separate remote database having personnel records of individuals working in the workplace and the method of monitoring the work practices of individuals further comprises the step of matching the data identifying the individual to one of the personnel records in the remote database.

### DETAILED DESCRIPTION OF THE INVENTION

The invention will now be more clearly understood from the following description of some embodiments thereof, given by way of example only, in which:

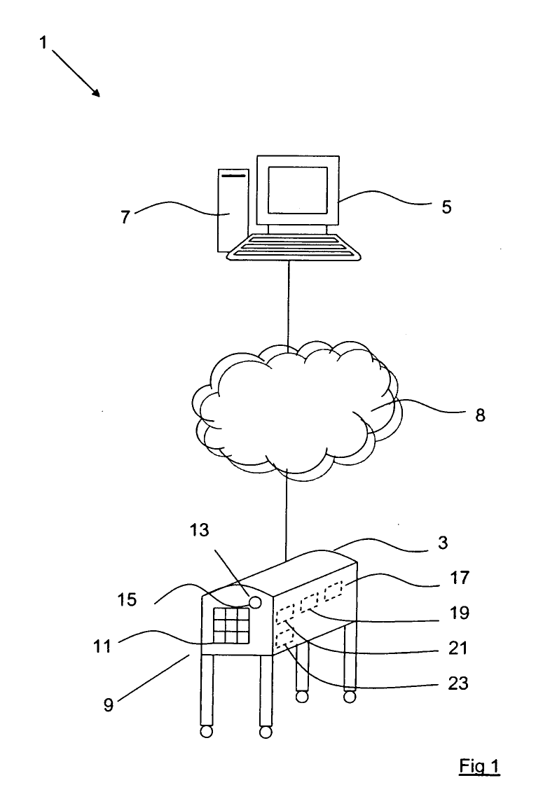

FIG. 1 is a diagrammatic representation of a system in which the method according to the present invention is performed;

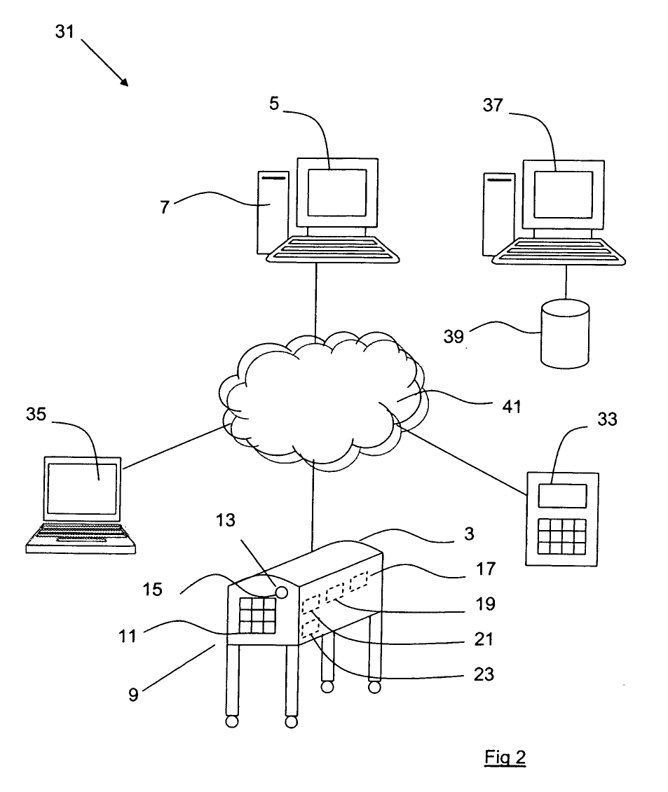

FIG. 2 is a diagrammatic representation of a system in which the method according to the invention is performed.

Referring to the drawings and initially to FIG. 1 thereof, there is shown a system, indicated generally by the reference numeral 1, comprising a portable medicament dispensing station 3, a remote monitoring unit 5 having a memory 7 and a communication network 8 connecting the medicament dispensing station 3 to the monitoring unit 5. The medicament dispensing station 3 further comprises a first identification means 9 provided by way of a keypad 11 and a second identification means 13 provided by way of a video camera 15. The medicament dispensing station 3 further comprises a clock 17, a controller 19, a communication means 21 and a releasable locking mechanism 23, all of which are internal the medicament dispensing station and are shown in outline.

In use, an individual that attempts to dispense a medicament from the medicament dispensing station will provide both a first identifier and a second identifier to the medicament dispensing station. The first identifier will typically comprise a numeric or alphanumeric identification code particular to that individual input by the individual on the keypad 11. The second identifier will be a short video clip of the individual taken by the video camera 15. The medicament dispensing station 3 captures the time at which the individual attempts to dispense the medicaments and transmits the first identifier, the second identifier and the time to the remote monitoring unit over the communications network. The remote monitoring unit stores the captured first identifier, second identifier and time in remote monitoring unit memory for future reference.

As an alternative to a video image, it is envisaged that the second identifier may comprise a photograph in which case the second identification means 13 will be provided by a camera. Alternatively, it is envisaged that the second identifier may comprise a fingerprint, retina scan or other biometric data unique to an individual in which case the second identification means 13 will be provided by a suitable means to capture the biometric data, for example a fingerprint scanner or a retina scanner. The specific construction of the second identification means are not important, what is important is the fact that there are two distinct identification means, one of which can irrefutably identify the individual dispensing the medicaments or blood products from the medicament dispensing station.

As an alternative to the identification code being provided manually by the individual on the keypad, the identification code could be stored on a data carrier which in turn is carried by the individual and captured in an unobtrusive, automatic fashion. For example, the identification code could be provided by way of an RFID card carried by the individual in which case there would be an RFID reader on the medicament dispensing station instead of or in addition to the keypad. As a further alternative still, the identification code may be supplied by a transmitter worn by the individual and an appropriate receiver on the medicament dispensing station would be provided instead of or in addition to the keypad to pick up the transmitted signal. It is envisaged that having a keypad will be advantageous so that additional information that may be required to allow dispensing of certain medicaments or blood products may be provided by the individual. For example, it may be necessary to enter a patient identifier and/or the medicament that is to be administered to them prior to the medicament being released. Other data entry means such as a bar code scanner (not shown) for reading bar code data on packaged medicaments or identification badges worn by employees may also be provided if desired.

Referring to FIG. 2 of the drawings, there is shown an alternative system in which the method according to the invention may be performed, where like parts have been given the same reference numerals as before. The system, indicated generally by the reference numeral 31, further comprises a PDA 33, a laptop computer 35 and a separate stand-alone PC 37 and database 39. The database 39 has personnel records of individuals working in the hospital stored thereon along with at least one of the unique identifiers of the individuals. If it is necessary to check the records relating to a particular incident, an operator of the monitoring unit may determine which unique identifier related to a particular incident and send that unique identifier to the operator of the stand-alone PC and database. The operator of the stand-alone PC 37 can compare the unique identifier provided with the unique identifiers in the database and retrieve the personnel records on their behalf. In this instance, the operator of the monitoring unit may only be able to have access to the unique identifiers in the monitoring unit that will protect the anonymity of the individual, such as a numeric or alphanumeric code identifier and not a video clip identifier or the like. Therefore, a degree of security may be brought into the system by having the records of individuals relating to the unique identifiers stored off site on a separate stand-alone PC 37 and database 39.

Another feature of the embodiment described in FIG. 2 is that a full audit of the work practices of the individuals may be achieved in a very simple manner. The communications network 41 is preferably a low-powered ZigBee network similar to that described in the applicants own co-pending PCT patent application no. PCT/EP2006/062895, the entire disclosure of which and in particular the disclosure relating to the use of and the tracking of the position of the mobile network unit in the ZigBee network is enclosed herein by way of reference. The position of the individual in the ZigBee network is tracked throughout the day by determining the exact or approximate position of their mobile network unit each time it communicates with one or more fixed network units (not shown) in the ZigBee network. In this way, the location of the individual in the hospital will be known.

In use, the PDA 33 and the laptop computer 35 may be used by an individual to input details of the work carried out by them. Each of the individuals will have a mobile network unit 43 forming part of the ZigBee network carried on their person. The mobile network unit may be used to provide the identification code to the PDA 33 or laptop computer 35 which in that case would be provided with a suitable receiver for identifying the mobile network unit. Alternatively, the user may enter a first identifier on the keypad of the laptop or PDA. A second identifier may also be captured using a camera, video camera or biometric scanner (not shown) provided on the PDA 33 or laptop 35. When the individual inputs details of a job just performed by them in the course of their duties into the PDA or laptop, e.g. in the case of a cleaner, that the cleaner has cleaned an operating theatre, the position information relating to the cleaner over a given period of time will also be sent to the monitoring unit and collated with the task data. In this way, it will be possible to verify that an individual was in the theatre for a given period of time when they claim that they cleaned the theatre and similarly, that the individual spent sufficient time cleaning the theatre.

This allows for identification of irregularities in work practices. For example, if an individual states that they performed a certain task such as cleaning the theatre but it is found from their position data that they were not in the vicinity of the area where the work was to be carried out, or that they were not there for a sufficient time to allow the work to be completed adequately, this pattern may be identified through routine checks and rule based comparisons. As an alternative to the PDA or laptop, a dedicated station with a touch screen could be provided for the workers to record their work progress and indeed this may be preferable for those workers not particularly skilled with computers. Similarly, pictorial images could be provided on the touch screen for those with language difficulties. Furthermore, a touch screen will allow for a very quick entry of the work done and if desired for a confirmatory message to be provided by a supervisor that they have checked the work that has been done and that it is satisfactory. Again, the confirmatory message may be stored in memory for future reference.

It is envisaged that the medicament dispensing station will be provided with memory and information relating to individuals and patients including their required medication types and doses and the controller can check the medication being administered to a particular patient for accuracy before the individual administers the medicament. Records of the correct medication and the doses may alternatively be stored on the remote monitoring unit and communication between the monitoring unit and the medicament distribution station may be necessary to gain authorisation to administer particular medicaments. In this case means will be provided to alert the individual that they may be about to administer the incorrect medicament if that is the case. Furthermore, the controller can determine whether the individual attempting to dispense medicaments from the medicament dispensing station is permitted to do so and can prevent unauthorised access to the medicaments in the medicament dispensing station. Finally, the medicament dispensing station may contain medicaments, blood products or indeed may be an organ transport vessel for transporting organs and the access to that organ transport vessel may be closely monitored and controlled if desired.

Furthermore, instead of having the devices operate in a low-powered wireless communications network, each device could be operated as a stand-alone unit and, if desired, information could be downloaded periodically through normal storage devices and collated with other information as required. Alternatively, the laptop, PDA or processing unit could be connected through wired or wireless connection to the internet or an intranet and could transmit information to other devices or to a monitoring unit over the internet/intranet. What is important is that in sensitive areas such as medical facilities, veterinary facilities, beverage facilities and food preparation facilities, a high level of accountability may be achieved by closely monitoring individuals and reporting on the activities carried out by those individuals.

The hardware used in the specification described above is not intended to be limiting and instead of keypads, voice activation software or touch screen apparatus may be used if preferred. Furthermore, the three devices shown, namely, the PDA, the laptop and the processing unit are not intended to be in any way limiting and a PC, telephone using SMS, WAP or other similar technology or other computing device could equally well be used. It will be understood that each of the entries will be time and date stamped using a universal system clock which may be synchronized with each unit periodically and preferably daily, at the same time each day. If necessary, the information may be encrypted during transmission for security reasons and access permission may be designated to certain individuals.

One further benefit of the auditing system is that it is envisaged that it may be used for training and educational purposes. It is further envisaged that training nurses, staff members in need of training and the like may be required to operate with the system at all times and they may be graded on their effectiveness and compliance with certain requirements.

In the specification the terms “comprise, comprises, comprised and comprising” and the terms “include, includes, included and including” are considered all deemed totally interchangeable and should be afforded the widest possible interpretation.

The invention is not limited to the embodiment hereinbefore described, but may be varied in both construction and detail within the scope of the claims.

1-23. (canceled)

24. A method of monitoring the dispensing of medicaments in a hospital, in a system comprising a portable medicament dispensing station, a remote monitoring unit having memory and a communication network connecting the medicament dispensing station and the monitoring unit, each time an individual attempts to dispense medicaments from the medicament dispensing station the method comprising the steps of:
the medicament dispensing station capturing a first identifier relating to the individual attempting to dispense medicaments from the medicament dispensing station;
the medicament dispensing station capturing a second identifier relating to the individual attempting to dispense medicaments from the medicament dispensing station;
the medicament dispensing station capturing the time at which the individual attempts to dispense medicaments from the medicament dispensing station;
transmitting the captured first identifier, second identifier and time from the medicament dispensing station to the remote monitoring unit over the communications network;
the remote monitoring unit storing the captured first identifier, second identifier and time in remote monitoring unit memory for future reference.

25. The method as claimed in claim 24 in which the step of capturing a first identifier comprises capturing an identification code from the individual.

26. The method as claimed in claim 24 in which the step of capturing a second identifier comprises capturing a photographic image of the individual.

27. The method as claimed in claim 24 in which the step of capturing a second identifier comprises capturing a video clip of the individual.

28. The method as claimed in claim 24 in which the step of capturing a second identifier further comprises capturing biometric data of the individual.

29. The method as claimed in claim 24 in which the method further comprises capturing position data relating to the individual in the hospital when they attempt to dispense medicaments, transmitting the position data to the monitoring unit and storing the position data in memory.

30. The method as claimed in claim 24 in which the medicament dispensing station further comprises a releasable locking mechanism and in which the method further comprises the step of the releasable locking mechanism only being released on the medicament dispensing station capturing both the first and second identifiers.

31. The method as claimed in claim 30 in which the method comprises the step of authenticating the individual from at least one of the first and second identifiers and releasing the releasable locking mechanism on the individual being authenticated.

32. The method as claimed in claim 31 in which the step of authenticating the individual comprises the monitoring unit comparing at least one of the first and second identifiers with data relating to the individual in memory and sending an authentication response to the medicament dispensing station permitting or refusing release of the releasable locking mechanism depending on the comparison of the identifier and the data in memory.

33. The method as claimed in claim 24 in which the system further comprises a separate remote database having personnel records of individuals in the hospital and the method of monitoring the dispensing of medicaments further comprises the step of matching one of the captured first identifier and second identifier in the remote monitoring unit memory to one of the personnel records in the database.

34. A medicament dispensing monitoring system comprising at least one portable medicament dispensing station and a remote monitoring unit, in communication with each other by way of a communication network, the monitoring unit having memory for storage of monitoring data thereon, the medicament dispensing station having a first identification means to receive a first identifier relating to an individual dispensing medicaments from the medicament dispensing station and a second identification means to receive a second identifier relating to the individual dispensing medicaments from the medicament dispensing station and a clock, the medicament dispensing station further comprising means to transmit the first and second identifiers along with time data to the remote monitoring computer over the communication network and the monitoring computer having means to store the first and second identifiers and the time data in memory as monitoring data.

35. The medicament dispensing monitoring system as claimed in claim 34 in which the first identification means further comprises means to receive an identification code from the individual.

36. The medicament dispensing monitoring system as claimed in claim 34 in which the second identification means further comprises means to capture a photographic image of the individual.

37. The medicament dispensing monitoring system as claimed in claim 34 in which the second identification means further comprises means to capture a video clip of the individual.

38. The medicament dispensing monitoring system as claimed in claim 34 in which the second identification means further comprises means to capture biometric data of the individual.

39. The medicament dispensing monitoring system as claimed in claim 34 in which the system further comprises means to capture position data relating to the individual.

40. The medicament dispensing monitoring system as claimed in claim 34 in which the medicament dispensing station is further provided with a releasable locking mechanism, the releasable locking mechanism being released on the medicament dispensing station capturing both the first and second identifiers.

41. The medicament dispensing monitoring system as claimed in claim 40 in which the system comprises means to authenticate at least one of the first and second identifiers and means to release the releasable locking mechanism on authentication of at least one of the identifiers.

42. The medicament dispensing monitoring system as claimed in claim 34 in which the system further comprises a separate remote database having personnel records of individuals in the hospital and means to match one of the captured first identifier and second identifier in the remote monitoring unit memory with one of the personnel records in the database.

43. A method of monitoring work practices of an individual in a workplace, in a system comprising a data entry module, a remote monitoring unit having memory and a communication network connecting the data entry module and the monitoring unit, the individual having an identification tag thereon and the system having means to determine the position of the individual wearing the identification tag in the workplace over time, the method comprising the steps of:
tracking the position over time of the individual in the workplace;
sending the position data of the individual to the monitoring unit for storage in monitoring unit memory;
the individual entering task data in the data entry module indicating that a task has been completed along with data identifying the individual;
sending the task data to the remote monitoring unit for storage in monitoring unit memory;
collating the position data and the task data for subsequent inspection.

44. The method as claimed in claim 43 in which the communication network is a low powered ZigBee network comprising a plurality of fixed nodes and the identification tag worn by the individual comprises a wireless mobile node of the ZigBee network, and in which the method step of tracking the position over time of the individual in the workplace further comprises tracking the position over time of the wireless mobile node in the ZigBee network.

45. The method as claimed in claim 43 in which there is provided a separate remote database having personnel records of individuals working in the workplace and the method of monitoring the work practices of individuals further comprises the step of matching the data identifying the individual to one of the personnel records in the remote database.

46. The method as claimed in claim 43 in which the method further comprises the step of a supervisor sending verification data relating to the successful completion and inspection of the task from a data entry module to the remote monitoring unit and the remote monitoring unit storing the supervisor data in memory.

47. The method as claimed in claim 43 in which the individual is a cleaner and the task data relates to a cleaning task.

48. The method as claimed in claim 43 in which the step of the individual entering data identifying the individual further comprises the step of the data entry module capturing a first identifier.

49. The method as claimed in claim 48 in which the step of capturing a first identifier comprises capturing an identification code from the individual.

50. The method as claimed in claim 48 in which the step of capturing a first identifier comprises capturing an identification code from an identification tag worn by the individual.

51. The method as claimed in claim 48 in which the step of the individual entering data identifying the individual further comprises the step of the data entry module capturing a second identifier.

52. The method as claimed in claim 51 in which the step of capturing a second identifier comprises capturing a photographic image of the individual.

53. The method as claimed in claim 51 in which the step of capturing a second identifier comprises capturing a video clip of the individual.

54. The method as claimed in claim 51 in which the step of capturing a second identifier further comprises capturing biometric data of the individual.
